(19) United States
(12) Patent Application Publication
(10) Pub. No.: US 2008/0246604 A1
(43) Pub. Date: Oct. 9, 2008

(54) Wireless interface module

(76) Inventors: Wayne McPherson, Ottawa (CA); Kelly Gravelle, Poway, CA (US); David Roscoe, Ottawa (CA); Randall Wood, Ottawa (CA); Mostafa Kassem, Orleans (CA)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/905,896

(22) Filed: Oct. 5, 2007

Related U.S. Application Data
(60) Provisional application No. 60/849,767, filed on Oct. 6, 2006.

(51) Int. Cl. H04Q 7/00

(52) U.S. Cl. 340/539.27; 340/539.1

(57) ABSTRACT

A system and method that allows remote monitoring by satellite of cargo carried on a mobile conveyance. The system and method provide for a wireless information module (WIM) on the conveyance for transmitting and receiving data from a plurality of wireless devices on the conveyance over a short range wireless network. The WIM relays data to a remote monitoring facility via satellite. Other applications of the system and method include, but are not limited to, remotely controlling wireless devices on a conveyance such as door lock sensors and electronic seals, remotely upgrading the software loaded on the devices within the mobile conveyance, and creating an ad-hoc network of multiple WIMs to maintain satellite communication with all WIMs in the network when certain of the WIMs are unable to communicate directly with a satellite.

The present application claims the benefit of U.S. Provisional Patent Application No. 60/849,767, filed Oct. 6, 2006, whose disclosure is hereby incorporated by reference in its entirety into the present application.

### BACKGROUND OF THE INVENTION

The invention relates to the field of wireless communication and, more particularly, is related to a system and method for remote cargo monitoring using satellite and wireless communications technology.

When cargo containers are transported, it is often desirable for an entity to be able to monitor the status of the cargo within the containers for the duration of transport. Such a capability is advantageous when, for example, the cargo transported must remain at a particular temperature for the duration of the journey. If the monitoring entity is able to detect when the temperature of a cargo container is reaching critical levels, the entity may be able to take steps to rectify the situation, possibly preventing the cargo from damage before it becomes too late.

Maintaining communication with the cargo transporter is one way to monitor the status of the cargo. The transporter may be able to provide information such as location and time to destination, and can verify that accessible doors of cargo containers are locked. However, such a method does not provide real-time feedback as to the status of the cargo at any given moment. In addition, the monitoring entity may require status information that the transporter may not have access to or may not be able to provide with a mere visual inspection of the cargo. Even if the transporter could inspect the cargo to retrieve the type of information required by the monitoring entity, the nature of the transportation method may prevent the transporter from accessing all of the cargo, as in the case where several cargo containers are stacked on top of and next to each other, as on an ocean shipping liner.

### SUMMARY AND OBJECTS OF THE INVENTION

It should be apparent that there exists a need for a system and method for remotely monitoring cargo. There also exists a need for a wireless information module that can coordinate and collect data from cargo sensors, seals, and locks for relaying via satellite to a remote monitoring facility. As the wireless interface module is to function in applications requiring transportability, the module should function in an un-tethered environment. To facilitate and simplify such a system, the wireless interface module should require low operating power. There also exists a need for a wireless interface module that maintains maximal communication with a remote monitoring facility via satellite during cargo transport.

Accordingly, a principal object of the present invention is to provide systems and methods for remotely monitoring cargo, by providing a wireless interface module (WIM) on a cargo conveyance for communicating with one or more wireless cargo monitoring devices and sending and receiving data to a remote monitoring facility via satellite.

It is another object of the present invention to provide a system and method for maintaining a remote connection with a WIM aboard a conveyance, by allowing a plurality of wireless interface modules to form an ad-hoc network so that each of the WIMs may maintain satellite connection as long as one WIM does so.

It is still another object of the present invention to provide a system and method for remotely monitoring cargo using a WIM with low operating power requirements.

It is another object of the present invention to provide a system and method for remotely monitoring cargo wherein software loaded on the WIM can be upgraded remotely.

It is still another object of the present invention to provide a system and method for remotely monitoring cargo wherein the remote monitoring devices are resistant to environmental extremes.

Briefly described, these and other objects and features of the present invention are accomplished, as embodied and fully described herein, by a system for monitoring cargo, comprising at least one wireless device, at least one wireless interface module configured to detect the at least one wireless device, a monitoring facility for remotely monitoring the status of the cargo, and a satellite configured to transmit and receive signals to and from the at least one wireless interface module and the monitoring facility.

The system includes a wireless interface module and wireless devices configured for low operating power requirements, to maintain a wireless link at a range of about 200 m in clear line-of-sight, and to withstand environmental extremes.

The system further includes a GPS module for receiving data from one or more GPS satellites and a wireless interface module configured to transmit and receive a signal from a second wireless interface module.

The above objects and features of the present invention are accomplished, as embodied and fully described herein, by a method for remotely monitoring cargo, comprising the steps of receiving at a wireless interface module over a short range wireless communications network data from a set of one or more wireless devices for monitoring cargo, transmitting said data to a communications satellite for relay to a monitoring facility, receiving the data at the monitoring facility, and processing the data at the facility to monitor the status of a cargo shipment.

With these and other objects, advantages, and features of the invention that may become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a schematic drawing depicting an architecture of a remote cargo monitoring system according to one aspect of the present invention;

FIG. 2 is a functional block diagram of a short range wireless device according to one aspect of the present invention;

FIG. 3 is a functional block diagram of a wireless interface module according to one aspect of the present invention;

FIG. 4 is a diagram of a typical transport application according to one aspect of the present invention;

FIG. 5 is a message flow diagram according to one aspect of the present invention;

FIG. 6 is schematic drawing depicting connection modes of a wireless interface module according to one aspect of the present invention;

FIG. 7 is a schematic drawing of an ad-hoc network of wireless interface modules according to aspect of the present invention; and

FIG. 8 is a functional block diagram of a configuration and control tool according to one aspect of the present invention.

### DETAILED DESCRIPTION OF THE PREFERRED EMBODIMENT

Several preferred embodiments of the invention are described for illustrative purposes, it being understood that the invention may be embodied in other forms not specifically shown in the drawings. Monitoring of cargo on a conveyance during transport is described herein for illustrative purposes, it being readily apparent to a person of skill in the art that the invention may be applied to other applications wherein monitoring the condition of an item using a wireless interface module, wireless devices, and satellite communications is advantageous.

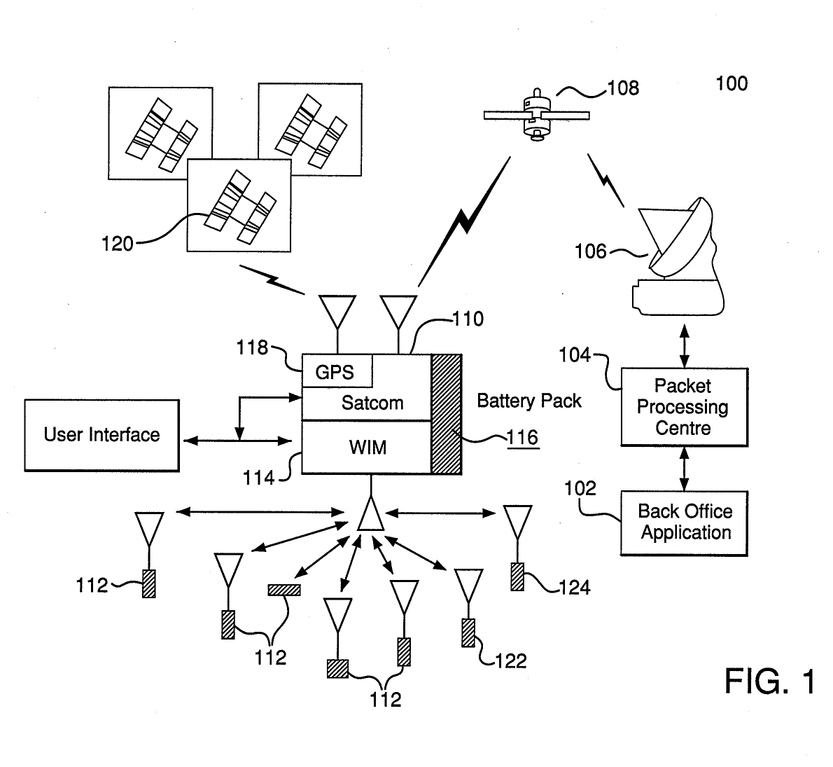

Turning first to FIG. 1, shown therein is a drawing depicting a schematic of the system architecture of a remote cargo monitoring system 100 according to one aspect of the present invention. The system 100 includes a remote monitoring facility housing the back office monitoring applications 102 and a packet processing center 104 for processing data in conjunction with an Earth station facility 106 for transmitting and receiving a signal to one or more orbiting satellites 108. The system further includes on a cargo conveyance a satellite communications module 110, one or more wireless devices 112 for monitoring conditions of the cargo on the cargo conveyance, and a wireless interface module (WIM) 114 for wirelessly sending and receiving data to and from the wireless devices 112 and for relaying data to and from the satellite communications module (SatCom) 110 for communication with the satellites 108.

The SatCom 110 allows for the integration of an L-Band satellite communications capability and integral GPS 118 communications capability with GPS satellites 120. A UHF wireless communications capability (both one-way and two-way) between the WIM 114 and the wireless sensors, seals and tags 112 allows for collection of monitoring data and transmission of commands to wireless devices 112. The two-way UHF communication network also provides a UHF remote firmware upgrade capability via a software upgrade access point 122. The software access point 122 allows the software loaded on the WIM 114 to be upgraded via the UHF short range wireless network as described in further detail below. While the present embodiment describes a UHF short range wireless (SRW) network, it will be apparent to those skilled in the art that other SRW networks can be employed.

The WIM 114 may communicate with the SatCom terminal 110 via a serial link, while maintaining a wireless communication link with the UHF sensors seals, and tags 112. The sensors 112 may provide such functions as remote locks and seals, proximity detection, and environmental information such as temperature, pressure, and vibration. Of course, none of these functions is required, and other functions may also be included.

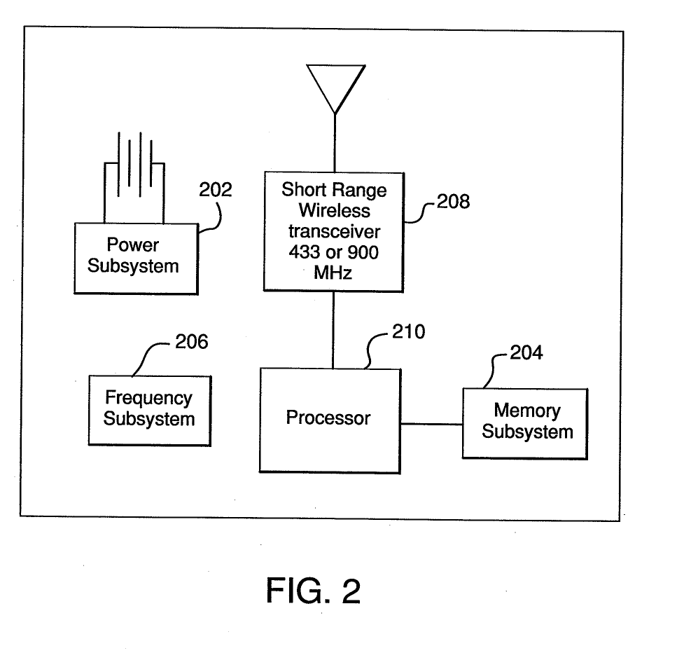

A functional block diagram of the UHF wireless sensor device is depicted in FIG. 2. The SRW device 112 may include battery power subsystem 202 and baseband processing subsystem including a memory subsystem 204 employing either or both volatile and non-volatile storage, a frequency subsystem 206 capable of synthesizing clocking pulses including a minimum 32.768 kHz, an RF subsystem 208 capable of communication at about 433 MHz and/or about 900 MHz and a processor 210 for coordinating the functions of the SRW device 112. Other operating and communication frequencies may be used as desired and are within the scope of this invention. According to the present invention, it is possible to maintain a wireless link over an extended range. For example, it is possible to maintain a wireless link at a range of about 200 m. Line of sight, as well as other factors, may affect the operating range.

Each device may be enclosed in a stand-alone environmental enclosure with its own battery. However, other configurations are within the scope of this invention. As a non-limiting example, the size may be about 4″ long by about 4″ wide by about 0.8″ high. Of course, other configurations are within the scope of the present invention.

A connector interface may be provided, for example, a USB interface, FireWire Interface, or other suitable interfaces are within the scope of the invention. However, it is possible to not provide a connector interface if desired. The units may be configured at the time of manufacture based on customer preference. It is also possible to provide a configuration capability over the RF 208 (or other suitable) link.

Power consumption by the power subsystem 202 may be less than 2.4 mAH per day, for example, when the device is in sleep mode until awakened by the occurrence of an alarm. As an example, the unit may operate using AA alkaline batteries. As a result, the present invention may be less sensitive to power consumption.

A SRW device may have the following operating modes. These operating modes may be based on selective shutdown of the regulators supplying the various subsystems.
Off. In off mode, there may be no battery power.
Sleep. Sleep mode may be the lowest power mode. Only selected portions of the baseband subsystem may be powered.
Processing. In processing mode, the baseband subsystem may be fully operational.
Receive. In receive mode, the baseband and the RF subsystem receiver may be operational.
Transmit. In transmit mode, the baseband and the RF subsystem transmitter may be operational.

A significant challenge in UHF network design is the association or registration of sensors and tags 112 with a particular WIM 114. This may be addressed in one of two ways: manual association or automatic association. Automatic association may be preferred but it may present challenges with respect to synchronization and power consumption. Manual association may be less desirable from a usage standpoint, as every sensor 112 generally must be manually associated with a particular WIM 114, but it does offer the advantage of almost immediate association and hence a more efficient power profile. As such, manual association may be used initially. A manual association device 124 may be provided to accomplish manual association of wireless devices 112 with a WIM 114 over the UHF network.

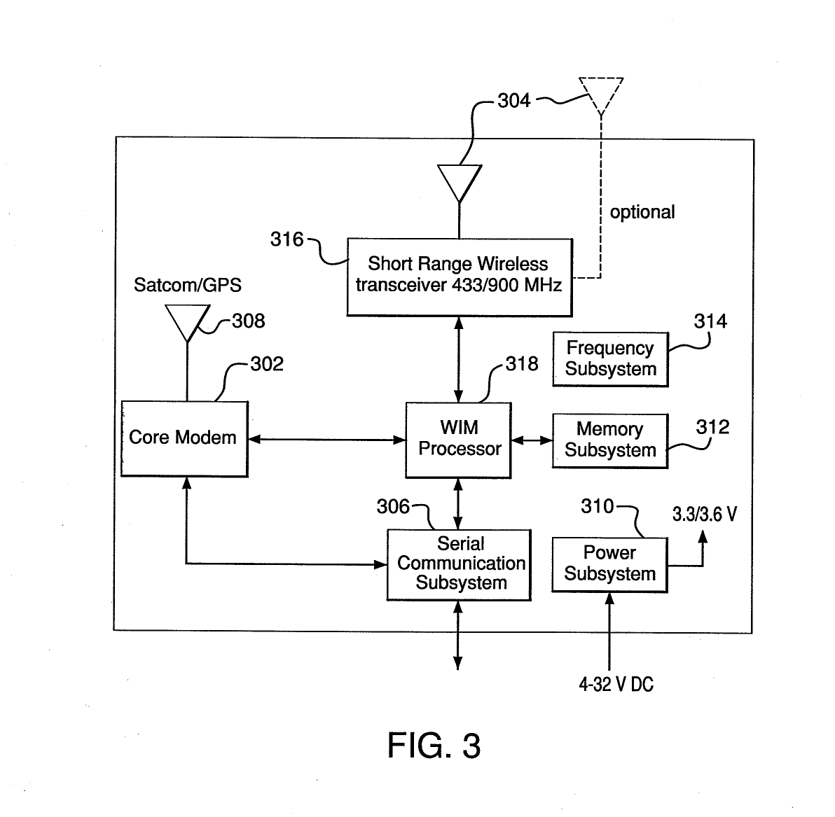

Turning now to FIG. 3, depicted therein is a functional block diagram of the WIM 114. The WIM-enabled terminal may include: A core modem 302 and antenna 308; a power subsystem 310, which may receive inputs of between about 4V to 32V input, preferably of DC input; a baseband processing subsystem including a serial communication subsystem 306 capable of communicating from about 2.4 kbps to about 115.2 kbps; a memory subsystem 312; a frequency subsystem 314 capable of synthesizing clocks; and an RF subsystem 316 capable of communication at about 433 MHz and about 900 MHz. The WIM functions are coordinated by a WIM processor 318. Other operating and communication frequencies may be used as desired and are within the scope of this invention. As a non-limiting example, the dimensions of the WIM unit 114 may be about 12″ long by about 4″ wide by about 0.8″ high. Of course, other configurations are within the scope of the present invention.

The WIM-enabled terminal may connect to external devices via a 5-pin male environmental connector 306. An exemplary pin configuration is illustrated in Table 1. However, other pin configurations are within the scope of this invention.

TABLE 1
WIM Pinout

| Pin | Function |
|---|---|
| 1 | Power (4-32 V DC) |
| 2 | RS232 Rx |
| 3 | RS232 Tx |
| 4 | Ground |
| 5 | Ground |

The memory subsystem 312 may be configured to include enough volatile memory to buffer an entire SatCom image plus an entire WIM image. Another memory subsystem that may use non-volatile memory for data that should be preserved across reset/power cycles may also be included.

The WIM 114 may be capable of maintaining a wireless link at extended ranges. For example, the WIM 114 may maintain a wireless link up to a range of about 200 m. However, that distance may increase or decrease, depending on line of sight and other factors known to those of skill in the art.

The WIM 114 may be designed and implemented in a power-sensitive manner, as it is expected that the units may be deployed on un-tethered assets. The design goal may be a life expectancy measured in years when the WIM 114 is connected to a standard battery pack 116, as shown in FIG. 1. However, other power sources are within the scope of this invention.

Desired features of the WIM 114 include the ability to connect with wireless sensors 112 from a number of different manufacturers, as well as the ability to support emerging ISO standards for electronic seals 118. The WIM subsystem 114 of a WIM-enabled terminal may be a low consumer of power. For example, the WIM subsystem 114 may contribute no more than 20% to the overall terminal power consumption in order to maximize battery life. That corresponds to an incremental current draw of no more than 5 mAH per day based on the following user profile: 30 minute wakeup with 1 GPS report per day (60 sec fix time), and the WIM subsystem operating 200 msec per hour.

It is possible to configure the WIM 114 and SatCom terminal 110 both locally and remotely. Local configuration may utilize either a wired RS232 link (SatCom and/or WIM) or the UHF SRW interface 124 (WIM only), as non-limiting examples. Remote configuration of the SatCom terminal 110 may be via the standard GlobalWave API or other satellite communications interface, while remote configuration of the WIM 110 and sensors 112 may utilize the GlobalWave short text message mechanism, allowing up to 38 bytes in the forward direction and up to 11 bytes in the return direction. Of course, those byte sizes are merely exemplary, and other data groupings or sizes are within the scope of the present invention.

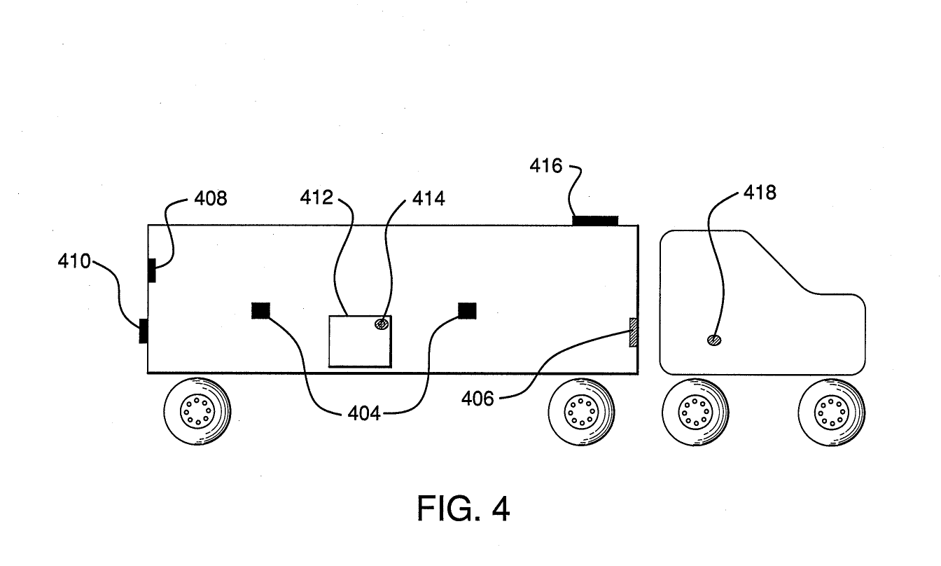

The WIM 114 may become a node in a network that connects the sensor devices 112 to the client 102. A typical transport application is shown in FIG. 4. The configuration of FIG. 4 is merely exemplary. Note that the enclosure for transporting the cargo 412 in a transport application (i.e. trailer, shipping container) is known as the conveyance 402. A WIM and SatCom terminal 416 are installed in a cargo conveyance 402. The WIM 416 may identify itself and the conveyance 402 being monitored to the back office application 102 using the unique ID of the tractor that is hauling the conveyance 402. The unique ID is provided to the WIM 416 by a wireless tag 418 fixed to the tractor.

Wireless monitoring devices 112 are fixed to the conveyance 402 or to the cargo 412 itself as required by the device functionality. In this embodiment, temperature sensors 404 are deployed to monitor temperature of the cargo during transport. Additionally, a cargo sensor 406 and a door sensor 408 collect additional data regarding the status of the cargo transported for relay to the monitoring facility. An e-seal door sensor 410 can be used to remotely control the status of the main door of the conveyance 402. An individual pallet 412 contained within the conveyance 402 is tagged with a pallet tag 414 that can relay information regarding the status of that particular pallet to the WIM and SatCom 416 for transmission to the Earth station facility 106 and back office application 102 via satellite 108. The pallet tag 414 may be, for example, a radio frequency identification (RFID) tag. If data contact is lost, the WIM 416 may relay a signal via the satellite 108 that the pallet 412 may have been offloaded or damaged. The signal will be detected at the back office application 102 so that appropriate measures may be taken.

A WIM-enabled terminal may have the following operating modes. One or more of these modes may be based on selective shutdown of the regulators supplying the various subsystems.
Off. In off mode, there may be no power connection to the terminal.
Sleep. Sleep mode is intended to be the lowest power mode. Only selected portions of the baseband subsystems may be powered.
WIM Processing. In WIM processing mode, the WIM baseband subsystem may be fully operational.
WIM Receive. In WIM receive mode, the WIM baseband and RF subsystem receiver may be operational.
WIM Transmit. In WIM transmit mode, the WIM baseband and RF subsystem transmitter may be operational.
Satcom Processing: In satcom processing, the Core Modem baseband subsystem may be operational.
Satcom Receive: In satcom receive, the Core Modem receiver and baseband subsystem may be operational.
Satcom Transmit: In satcom transmit, the Core Modem transmitter and baseband subsystem may beoperational.

It should be noted that combinations of the above modes are possible. For example, the following combinations are included: WIM Processing/Satcom Processing; WIM Processing/Satcom Receive; WIM Processing/Satcom Transmit; WIM-Receive/Satcom Processing; WIM Receive/Satcom Receive; WIM Receive/Satcom Transmit; WIM Transmit/Satcom Processing; WIM Transmit/Satcom Receive; and WIM Transmit/Satcom Transmit.

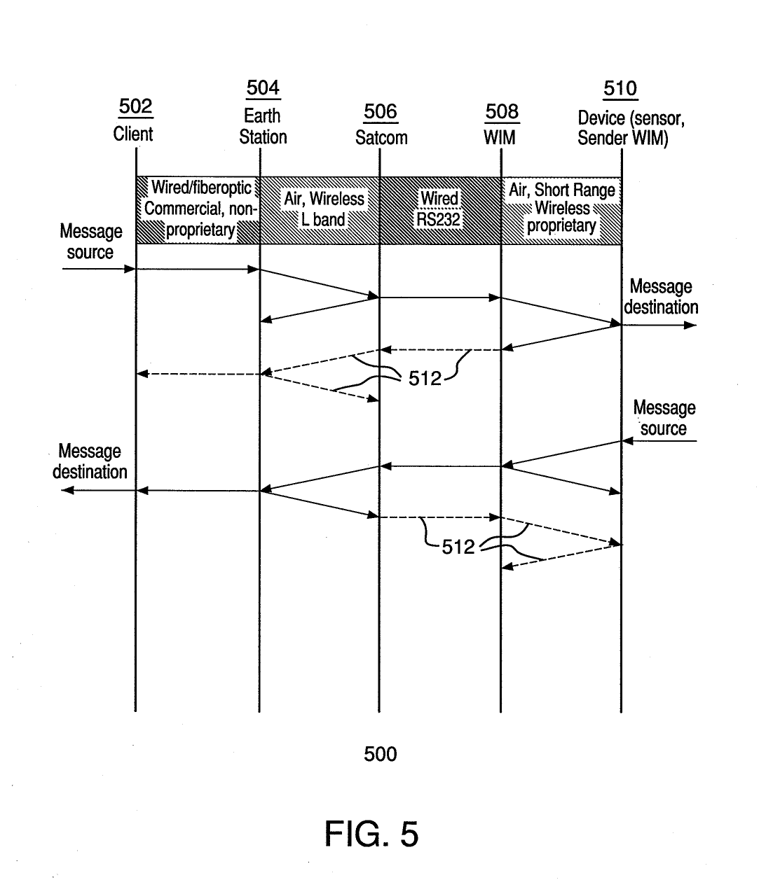

Turning now to FIG. 5, depicted therein is a message flow diagram showing how messages may be transferred across the system. The implication is that the satellite link is not blocked. The nodes in the network as shown in this diagram are: Client 502 (typically a back office application), Packet Processing Center 504 (PPC)—a site which processes the data received from the Earth Station 106, SatCom 506—which could be, for example, a Transcore GlobalWave terminal, WIM 508, and a wireless device 510 (sensors, tags etc.). However, these and other nodes may be added and/or removed, as desired. The monitoring data will be relayed via the SatCom 506 to the satellite 108 and forwarded on to the Client 502. For example, if an associated door seal 510 is opened, a real time message may be sent over the SRW link to the WIM 508 and forwarded on to the SatCom 506 for relay to the PPC 502 informing the monitoring facility that a door seal has been breached. If an associated tag 510 falls out of the zone of communication, the WIM 508 may send a message to the client 502 indicating a change of status. Optional acknowledgement messages may be sent from each node back to the sending node when a message is successfully received as shown by the dashed arrows 512 in FIG. 5.

Each manufacturer of wireless sensors 112 has adopted a proprietary protocol for their short-range wireless (SRW) connection and in many cases has chosen unique SRW frequencies as well. The protocols are not generally available to third parties to enable them to build their own units, known as readers, which communicate with and receive the data from the end devices. Instead, each manufacturer has created its own reader device for operation with its sensors, but few of these are suitable for WIM 114 use (i.e. low power applications). A useful feature of the WIM 114 is therefore to produce a module that is as simple as possible which reads as many of the different protocols and frequencies as necessary to achieve the sensing requirements.

The following description addresses two exemplary protocols. However, other protocols are within the scope of this invention. The first protocol is the EchoStream (ES) protocol. This system provides 1-way and 2-way wireless communications between a reader and end devices which are configured into a network during the setup of the system. Several sensors could be suitable for deployment in such a system. However, a 2-way capability and efficient power management is preferably incorporated. The ES system may be used to implement the WIM network because of the similarities. The second protocol is the emerging 18185 container standard utilized by HiGTek Corporation. This firm currently produces a variety of wireless locks and wireless seals which are suitable for use as end devices in the WIM application. It is also possible to adapt any of the HiGTek end devices to include a temperature sensor, an acceleration sensor, a tilt sensor, and an audio sensors. Of course, other sensors may also be included, and none of those sensors is required.

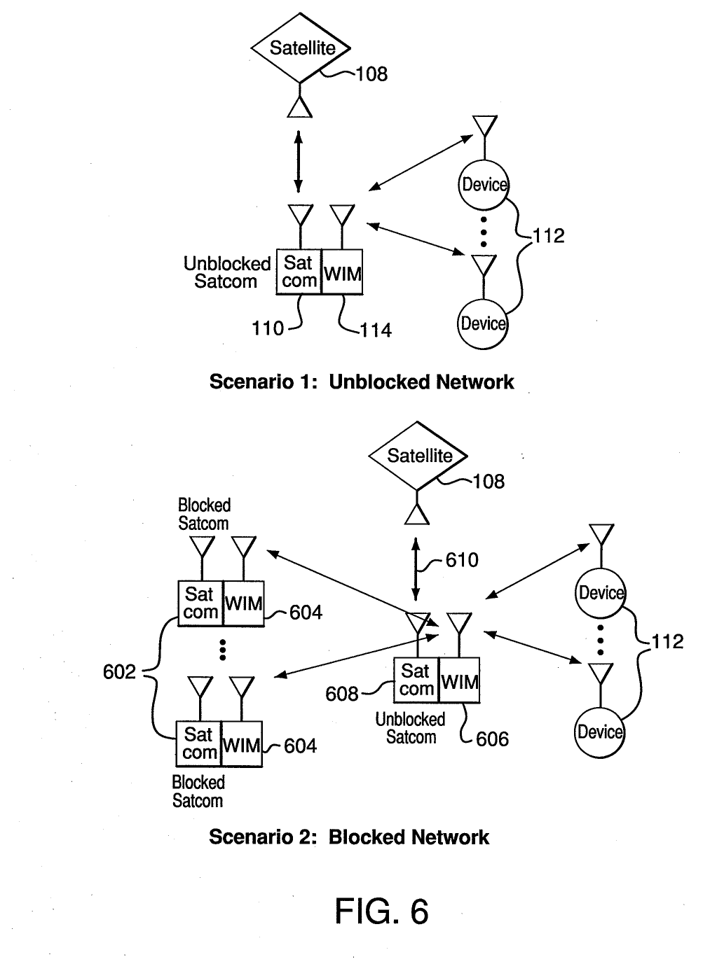

Turning now to FIG. 6, the WIM 114 may also be capable of communicating with other SatCom/WIM 110, 114 devices that are located on other (e.g., adjacent) cargo transport conveyances 402. This communication may be for the purpose of relaying data slated to be sent over the SatCom 110 link that cannot be currently sent on the originating terminal because the SatCom 110 link is blocked, as would happen if a container is stacked on top of another container, blocking communication to the satellite 108. Upon receiving a signal from the associated SatCom that it is blocked 602, the blocked WIM 604 may be able to link itself with a nearby WIM unit 606 (on adjacent conveyances for example) using the SRW communications network and forward its data through the nearby WIM unit 406 to a SatCom unit which is unblocked 608 and can transmit the data to the satellite 108 over a functional satellite link 610.

It is possible for a WIM that receives data from another WIM to forward this data on to another WIM in a chain towards the unblocked WIM 606. This series of transmissions may be desirable if the distance between the blocked 604 and the unblocked WIM 606 units is large. That may also be desirable with shipping containers, when a WIM is mounted on the top of a container and another container is stacked on top of it effectively sandwiching the WIM in a thin air space between the containers. As a result, it may be most effective to place the WIM at a height at which it can receive/send signals to/from the sandwiched WIM.

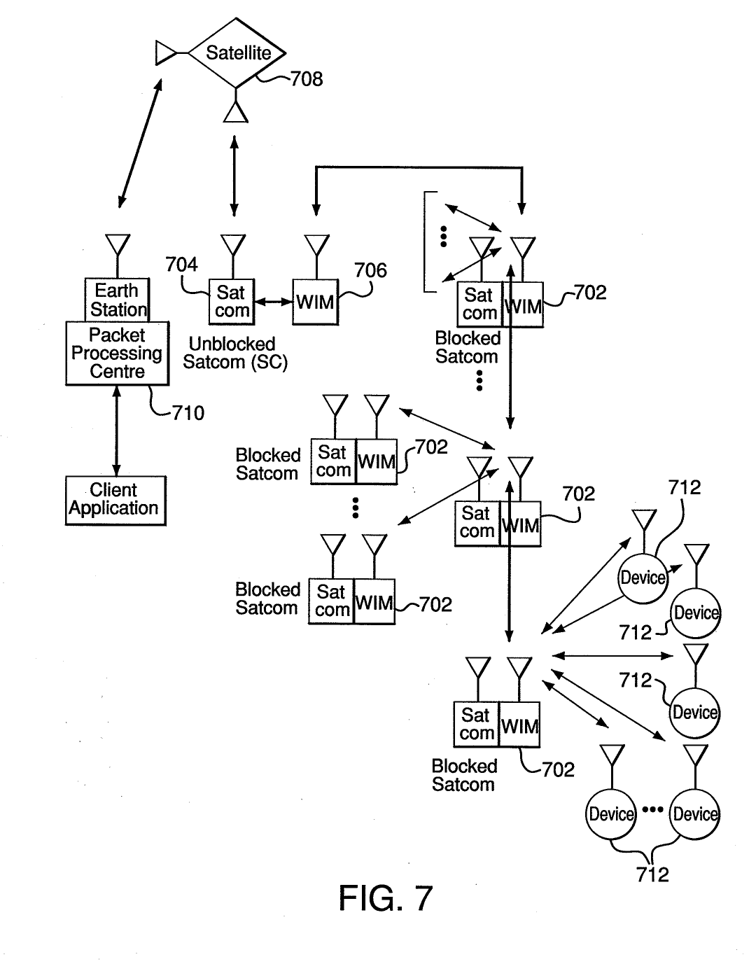

In another embodiment of the present invention described in FIG. 7, if the SatCom link is blocked, a process called WIM registration may be executed, whereby blocked WIM units 702 may be configured into a network of WIM units by communicating with nearby blocked and unblocked WIM units. WIM units participating in such a network have sender WIM and/or receiver WIM functions. The data from blocked WIM units 702 may be forwarded to an unblocked Satcom/WIM 704 in the center of the network (or other location) known as the Network Coordinator (NC) 706 and may be the point from which the data is transmitted through GlobalWave or other satellite network via the satellite 708 to the PPC 710. Both manual and automatic modes are included for the WIM registration function.

A network of WIM units connected in this way ensures that no data from any of the end devices is lost. This network is called the WIM Forwarding Network. To accommodate the different connection possibilities, the WIM maybe able to provide the following operating states:

1) Sender WIM: This state occurs if the WIM is blocked 702. The blocked WIM 702 may send its data to another WIM, possibly in a direction toward the WIM network coordinator 706. This data may include the data from the end devices 712 local to the sending WIM plus data received from other WIMs. The data received from the other WIMs is data received at the WIM through its operation as a Receiver WIM.

2) Receiver WIM: This state occurs once the WIM has established a connection with a unit which can accept the data that the WIM is handling. The Receiving WIM state may occur when the WIM has either connected to the satellite via its local Satcom 704, or has connected to another WIM (e.g., in a direction towards the network coordinator 706). That data may include data from the end devices local to the WIM 712 plus data received from other WIMs. The data received from the other WIMs may include data received at the WIM through its operation as a Receiver WIM. It is possible that a WIM unit can operate in both the Sender WIM state and the Receiver WIM state simultaneously.

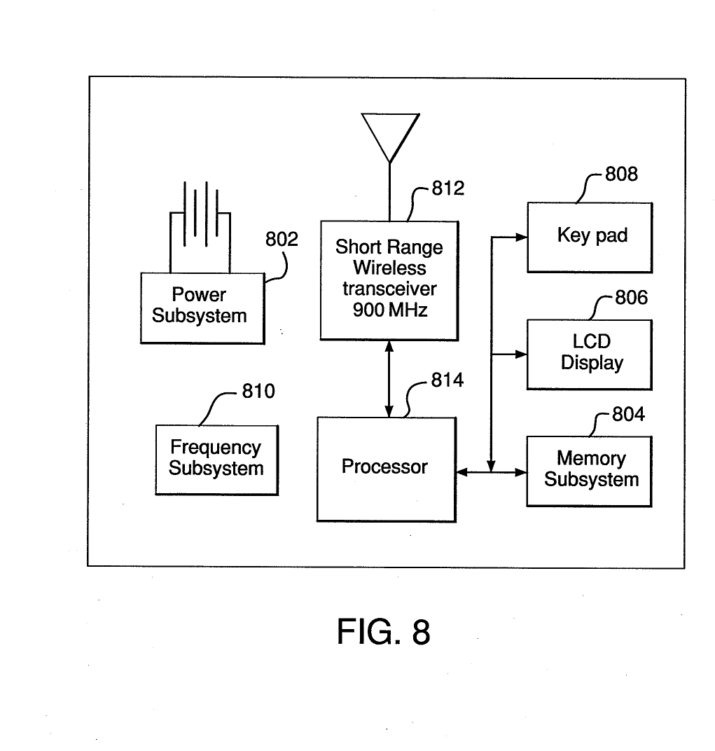

As previously discussed, association or registration of sensors and tags 112 with a particular WIM 114 can be accomplished in one of two ways: manual association or automatic association. A configuration and control tool may be provided to assist with the association as described in FIG. 8. The configuration and control tool may include a battery-operated hand-held device capable of: associating devices 112 with a particular WIM subsystem 114; configuring or reconfiguring a WIM subsystem 114; re-flashing a WIM subsystem 114; configuring or reconfiguring the SatCom subsystem 110; and re-flashing the SatCom subsystem 110.

In comparison to the WIM-enabled terminal 114 and short range wireless devices 112, the environmental requirements for this device may be substantially less stringent. This device may preferably meet the general environmental requirements for consumer electronics.

A configuration and control device may include the following subsystems: a switchable battery power subsystem 802; a baseband processing subsystem including a memory subsystem utilizing both volatile and non-volatile storage 804, an LCD display 806, and a membrane key pad 808; a frequency subsystem capable of synthesizing clocks that operate at different frequencies 810; an RF subsystem capable of communication at about 900 MHz (or other frequency) 812; and a processor for coordinating the functions of the configuration and control tool 814.

A configuration and control tool may have the following operating modes based on selective shutdown of the regulators supplying the various subsystems.
Off: In off mode, there may be no battery power.
Sleep: Sleep mode may be the lowest power mode. Only selected portions of the baseband subsystem may be powered. This may be entered if the power supply switch is on and there has been no activity for a desired length of time (e.g., five minutes).
Processing: In processing mode, the baseband subsystem may be fully operational.
Receive: In receive mode, the baseband and the RF subsystem receiver may be operational
Transmit: In transmit mode, the baseband and the RF subsystem transmitter may be operational.

Environmental Considerations

Operating Conditions

Environmental considerations see, e.g., SAE J1455 Recommended Environmental Practices for Electronic Equipment Design in Heavy-Duty Vehicle Applications Specification include those related to the electrical performance of the WIM-enabled terminal 114 and SRW devices 112 and/or to the mechanical integrity of the hardware enclosure when subjected to a variety of environmental tests. In the following description, the SAE J1455 specification is used to exemplify desired environmental considerations. However, other specifications are within the scope of this invention.

Temperature: The optimal temperature range for the specified performance to determine if the configuration satisfies environmental considerations, it is possible to include a testing technique during or after manufacture may be about −25 deg C. to about +55 deg C. The extended operational temperature range may be about −40 deg C. to about +85 deg C. as defined in SAE J1455, section 4.1.3.1 (24 hour Thermal Cycle) and section 4.1.3.2 (22 hour Thermal Shock). However, the temperature ranges may be adjusted based on other desired parameters or specifications.

Humidity: The WIM terminal 114 and SRW devices 112 may satisfy all performance and mechanical considerations during exposure to 90% relative humidity at +85° C. as defined in SAE J1455, section 4.2.3 (6 consecutive 8 hour humidity cycles per FIG. 4a).

Salt Spray: The WIM terminal 114 and SRW devices 112 may satisfy performance and mechanical requirements during exposure to a 5% salt spray at +35° C. for a period of 96 hours as defined in SAE J1455, section 4.3.3.

Splash: The WIM terminal 114 and SRW devices 112 may satisfy performance and mechanical requirements according to SAE J1455 Section 4.4.3 following exposure to the following:
Windshield Washer Fluid;
Diesel Fuel;
Degreasers;
Soap and Detergents;
Salt Water;
Paint strippers;
Spray Paint; and
Washer Solvent
   As well as other substances that might affect the performance of the WIM terminal 114 and SRW devices 112.

Immersion: The WIM terminal 114 and SRW devices 112 may meet performance and mechanical requirements after immersion in water according to SAE J1455 Section 4.4.3. The WIM 114 and SRW devices 112 may also comply with International Protection Standard IP 67 for protection from ingress of dust and temporary immersion. Other protection standards may also be satisfied, as desired.

Steam Cleaning and Pressure Washing: The WIM terminal 114 and SRW devices 112 may satisfy all performance and mechanical requirements when exposed to steam cleaning at 93° C. with a flow rate of 150 gallons/hour at a pressure of 203 lbft/in² and high-pressure spray with a flow rate of 150 gallons/hour at a pressure of 1020 psi as defined in SAE J1455, Section 4.5.3.

Dust and Sand Bombardment: The WIM terminal 114 and SRW devices 112 may meet all performance and mechanical requirements after exposure to dust and sand per SAE J1455 Section 4.7.3.

Mechanical Vibration

Swept Sine Vibration: The WIM terminal 114 and SRW devices 112 may operate under exposure to swept sine vibration from 10 Hz to 2000 Hz with a 2 g peak per SAE J1455 Section 4.9.4.1 and Appendix A, Category 3 therein.

Random Vibration: The WIM terminal 114 and SRW devices 112 may operate under exposure to cab mounted random vibration levels per SAE J1455 Section 4.9.4.2 and FIGS. 6, 7, and 8 therein.

Mechanical Shock: The WIM terminal 114 and SRW devices 112 may satisfy performance and mechanical requirements after exposure to positive and negative saw tooth shock pulses of 20 G for a duration of 11 ms as represented in SAE J1455, section 4.10.3.4. This performance criterion may apply to each of the three orthogonal axes.

Electrostatic Discharge: The WIM terminal 114 and SRW devices 112 may satisfy performance requirements after external surfaces have been subjected to 8 kV contact discharge per the Electromagnetic Compatibility for Industrial-Process Measurement and Control Equipment standard IEC 801-2 (Level 4 Immunity).

Electromagnetic Compatibility/Electromagnetic Interference: When employing the GlobalWave 0.5 second return link waveform in the United States, the WIM terminal 114 and SRW devices 112 may meet FCC Part 15 Class B, FCC Part 15 Class B and FCC part 25.202(f) and MSV Interface Access Requirements. When employing the GlobalWave 1.5 second return link waveform in the United States, the WIM terminal 114 and SRW devices 112 may meet FCC Part 15 Class B and FCC Part 15 Class B and FCC part 25.202(f). When employing the GlobalWave 1.5 second return link waveform and not operating in the United States, the WIM terminal 114 and SRW devices 112 may satisfy performance requirements according to ETSI EN 301 681.

Steady State: The WIM terminal 114 may satisfy performance requirements while being subjected to a combination of temperature and main power input voltage variations. The main power input may meet all performance requirements after being subjected to temperature and supply voltage variations as detailed in the SAE J1455 specification, section 4.11.1.1.

System Messaging

In any desired number of applications, communication between the SatCom terminal 110 and the WIM 114 may employ the GlobalWave short text message protocol. This mechanism provides up to 38 bytes in the forward direction and up to 11 bytes in the return direction. In the specific application of software upgrade described below in further detail, the WIM 114 may communicate with the SatCom terminal 110 using a special software upgrade protocol. The WIM 114 may employ the EchoStream protocol (or another desired protocol) when communicating with active short range wireless devices 112.

Integration into the GlobalWave Network: As mentioned above, integration into the GlobalWave satellite communications network may be accomplished through the short text message construct, and specifically employing embedded text messaging. Using this technique, the least significant 4 bits of the first byte may identify the device destination (forward direction) or source (return direction) of the data (Table 2), while the most significant 4 bits of the first byte may identify the message type (Table 3). Of course these bit configurations are merely exemplary, and other configurations known to those of skill in the art are within the scope of the present invention. The subsequent bytes may contain the data itself.

TABLE 2
Embedded Text Messaging Destination Identifiers

| Device Identifier | |
|---|---|
| (Byte 1, bits 0-3) | Embedded Application |
| 0 | Reserved |
| 1 | WIM |
| 2 | SRW 1 |
| 3 | SRW 2 |
| . | . |
| . | . |
| . | . |
| 15 | SRW 13 |

Table 3 provides an exemplary configuration of possible message types. Other message types are also within the scope of this invention.

TABLE 3
WIM Embedded Text Message Types

| Embedded Message Type | |
|---|---|
| (Byte 1, bits 4-7) | Function |
| 0 | Reserved |
| 1 | Configuration |
| 2 | Poll |
| 3 | Report |
| 4 | Event |
| 5 | Status |
| 6 | Auto-Calibrate |
| 7 | Reset |
| 8 | Software Upgrade |
| 9-15 | reserved/future |

Configuration Messages: Both the WIM 114 and the SRW devices 112 may include some basic configuration capability. Some expected configuration parameters include, but are not limited to:
measurement interval: how frequently to perform its measurement (WIM and SRW);
wakeup interval: how often to synchronize, with the SatCom in the case of the WIM, and with the WIM in the case of the devices (WIM and SRW);
alarm thresholds: at what is an alarm generated (SRW);
alarm filtering: how many consecutive samples above/below a threshold before a change of state is validated (SRW);
alarm configuration: alarm above a threshold, below a threshold, or both (SRW);
pre-scheduled reporting interval (WIM and SRW);
pre-scheduled report type (WIM);
hotspot update;
configuration acknowledgement;
configuration negative acknowledgements with error types; and
other configuration parameters, as desired.

Tables 4 and 5 detail forward and return link bit ordering. These are merely exemplary.

TABLE 4
Forward Configuration Message Content

| Bits | Description |
|---|---|
| 0-3 | Device Identifier |
| 4-7 | Message Type (1) |
| 8-303 | Configuration data |

TABLE 5
Configuration Reply Content

| Bits | Description |
|---|---|
| 0-3 | Device Identifier |
| 4-7 | Message Type (1) |
| 8-10 | Ack (0) |
| | Nack Types (1-7) |

Poll Messages: It is possible to poll the WIM 114 (and therefore SRW devices 112) through the use of message type 1. The poll type may be indicated by the most significant 4 bits of byte 2. Poll request and reply message bit definitions are given in Tables 6A and 6B. (Of course, these are merely exemplary.)

TABLE 6A
Poll Request

| Bits | Description |
|---|---|
| 0-3 | Device Identifier |
| 4-7 | Message Type (2) |
| 8-10 | Poll Type (0-7) |

TABLE 6B
Poll Reply

| Bits | Description |
|---|---|
| 0-3 | Device Identifier |
| 4-7 | Message Type (2) |
| 8-10 | Poll Type (0-7, definition tbd) |
| 11-87 | Poll content, definition tbd |

Reports: A feature of the WIM 114 may include reporting on a pre-scheduled interval. The supported report types may be the same as the poll types defined above. Table 7 details non-limiting exemplary bit definitions.

TABLE 7
Pre-Scheduled Report

| Bits | Description |
|---|---|
| 0-3 | Device Identifier |
| 4-7 | Message Type (3) |
| 8-10 | Report Type (0-7) |
| 11-87 | Report Content |

Events: The WIM 114 may be capable of generating an event/alarm based on a change of state of a prescribed device. Table 8 identifies exemplary event/alarm message content.

TABLE 8
Alarm Message Content

| Bits | Description |
|---|---|
| 0-3 | Device Identifier |
| 4-7 | Message Type (4) |
| 8-10 | Alarm Type (0-7, definition tbd) |
| 11-87 | Alarm Content (tbd) |

Status Messages It is possible to query a device 112 for its status. The messaging may include a status request and a status reply. Examples of a status request and status reply are illustrated in Tables 9 and 10, respectively.

TABLE 9
Status Request Message Content

| Bits | Description |
|---|---|
| 0-3 | Device Identifier |
| 4-7 | Message Type (5) |

TABLE 10
Status Reply Message Content

| Bits | Description |
|---|---|
| 0-3 | Device Identifier |
| 4-7 | Message Type (5) |
| 8-87 | Status data |

Auto-Calibration Message: The device 112 may also be capable of running a self-calibration. The device may further be capable of returning a result of the self-calibration. The messaging may therefore include a auto-calibration request and an auto-calibration reply example of which are Tables 11 and 12.

TABLE 11
Auto-Calibration Request

| Bits | Description |
|---|---|
| 0-3 | Device Identifier |
| 4-7 | Message Type (6) |

TABLE 12
Auto-Calibration Reply

| Bits | Description |
|---|---|
| 0-3 | Device Identifier |
| 4-7 | Message Type (6) |
| 8 | Ack (0)/Nack (1) bit |
| 9-87 | Data |

Reset Message: It is possible to remotely reset the WIM 114 and/or the peripheral SRW devices 112. Upon reset, the WIM 114 may consolidate the reset occurrences from each of the SRW devices 112 and may return a reset occurrence message. Exemplary message content is provided in Table 13. Note that the same message may be used in both the forward (request) and return (reply) direction.

TABLE 13
Reset Request/Reply

| Bits | Description |
|---|---|
| 0-3 | Device Identifier |
| 4-7 | Message Type (7) |

Software Upgrade Message: As previously discussed, it is possible to remotely request software upgrade (e.g., an automatic upgrade) for either the WIM 114 and/or the satellite communications terminal 110. Upon reception, the WIM 114 may go into a pre-configured “wake up” interval, whereby it attempts to establish a communication link at 2.4 GHz (or other suitable frequency) for a pre-configured amount of time. Once the new software has been retrieved and the appropriate device(s) has/have been re-programmed (or not), the WIM 114 may send a message indicating the upgrade status. Exemplary messages are detailed in Tables 14 and 15. The software upgrade feature is discussed in greater detail below.

TABLE 14
Software Upgrade Request

| Bits | Description |
|---|---|
| 0-3 | Device Identifier |
| 4-7 | Message Type (8) |
| 8-9 | WIM Upgrade (0) |
| | Terminal Upgrade (1) |
| | WIM and Terminal Upgrade (2) |
| | Unused (3) |

TABLE 15
Software Upgrade Reply

| Bits | Description |
|---|---|
| 0-3 | Device Identifier |
| 4-7 | Message Type (8) |
| 8-9 | WIM Upgrade (0) |
| | Terminal Upgrade (1) |
| | WIM and Terminal Upgrade (2) |
| | Unused (3) |
| 10-11 | Upgrade Status |
| | Upgrade Successful (0) |
| | Failed to Upgrade WIM (1) |
| | Failed to Upgrade Terminal (2) |
| | Failed to Upgrade Both (3) |

Integration into the EchoStream Protocol: The WIM may accept the short text messages as described previously and may convert them to the EchoStream protocol (or other suitable protocol) in order to communicate with the SRW devices.

Software Upgrade

It is possible to remotely upgrade the software residing in the WIM subsystem 114 and/or in the terminal 110. This may be achieved through the 900 MHz interface (or other suitable interface). At a minimum, the WIM 114 must be capable of buffering a combined WIM plus SatCom terminal software load. To ensure the highest reliability, the WIM 114 should be capable of buffering: the current SatCom software load, the new SatCom software load, the current WIM software load, the new WIM software load. This exemplary configuration will allow for almost complete fault tolerance since it will allow the WIM 114 to revert to its current software load, if possible, and restore the current SatCom software, if possible.

Upon reception of the complete software image, the WIM 114 may perform an error check to ensure that the image is valid. Upon confirmation, the WIM 114 may then upgrade the appropriate device (itself 114, the SatCom terminal 110, or both) and report the status through the GlobalWave interface.

The WIM 114 may be configurable independent of the SatCom GlobalWave short text message mechanism. The user may simply connect through an RS232 port (or other suitable connection interface) and enter a configuration menu via a break-in sequence during the boot sequence. The menu may enable the following tasks: load the application software, reload the boot software, launch the application, reset, display help.

Once the application is launched, it will be possible to enter a configuration/debug menu which will provide the following options: configure parameters, display the current configuration, reset the WIM, display help, other desired features.

It is also possible to upgrade a WIM enabled terminal 114 using a configuration and control device (or other suitable devices) described previously.

Factory Test Support: The WIM 114 may be capable of entering a mode to interface with functional test equipment. This may provide a means of exercising the hardware for the purpose of functionally testing the hardware at the time of manufacture.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

We claim:

1. A system for monitoring the condition of an item, comprising:
at least one wireless monitoring device for monitoring the item;
at least one wireless interface module in data communication with the at least one wireless monitoring device;
a monitoring facility for remotely receiving the condition of the item; and
a satellite configured to transmit and receive signals to and from the at least one wireless interface module and the monitoring facility.

2. The system of claim 1, wherein the wireless interface module and the at least one wireless device are configured for low operating power requirements.

3. The system of claim 1, wherein the at least one wireless interface module is configured to relay at least one signal from at least one second wireless interface module.

4. The system of claim 1, wherein the wireless interface module is configured to maintain a wireless range of about 200 m.

5. The system of claim 1, further comprising a GPS module for receiving data from one or more GPS satellites.

6. The system of claim 1, wherein the wireless interface module and the at least one wireless sensor are configured to withstand environmental extremes.

7. The system of claim 1, further comprising a configuration and control device for associating the wireless monitoring device with the wireless interface module.

8. The system of claim 1, wherein the wireless interface module is in data communications with a satellite communications terminal for transmitting and receiving data to and from the satellite.

9. A system for remotely monitoring a plurality of cargo conveyance units, the system comprising:
a plurality of wireless interface modules associated with the plurality of cargo conveyance units, wherein each cargo conveyance unit is associated with at least one wireless interface module;
a plurality of wireless monitoring devices for monitoring the condition of a cargo conveyance unit, the wireless monitoring device in data communications with at least one wireless interface module;
a satellite communications terminal in data communications with the wireless interface module;
a monitoring facility for remotely receiving the condition of the cargo conveyance unit; and
a satellite configured to transmit and receive signals to and from the satellite communications terminal and the monitoring facility.

10. The system of claim 9 wherein the wireless monitoring devices include temperature sensors, radio frequency identification tags, and electronic door seals.

11. A method for remotely monitoring the condition of an item, comprising, the steps of:
receiving at a wireless interface module over a short range wireless communications network data from a set of one or more wireless monitoring devices for monitoring the item;
transmitting said data to a communications satellite for relay to a monitoring facility;
receiving the data at the monitoring facility; and
processing the data at the facility to monitor the status of the item.

12. The method according to claim 11, further comprising the step of transmitting from the monitoring facility via the satellite to the wireless interface module data for controlling the wireless monitoring devices for monitoring cargo.

13. The method according to claim 11, further comprising the step of transmitting from the monitoring facility via the satellite to the satellite communications terminal and the wireless interface module data for updating software on one or both of the wireless interface module and the satellite communications terminal.

14. The method according to claim 11, wherein the set of wireless devices includes wireless sensors, wireless tags, and wireless electronic seals.

15. The method according to claim 11, wherein the wireless interface device may communicate with a nearby second wireless interface device for forwarding data when the wireless interface device is unable to communicate with the satellite.
